(19) United States
(12) Patent Application Publication
(10) Pub. No.: US 2014/0279570 A1
(43) Pub. Date: Sep. 18, 2014

(54) ELECTRONIC APPARATUS, COMPUTER READABLE RECORDING MEDIUM, AND MESSAGE MANAGEMENT SYSTEM

(71) Applicant: KYOCERA Document Solutions Inc., Osaka (JP)

(72) Inventors: Daisuke Yoshida, Osaka (JP); Yoshihiko Arai, Osaka (JP); Toyoaki Oku, Osaka (JP); Takeshi Nakamura, Osaka (JP); Koki Nakajima, Osaka (JP); Atsushi Matsumoto, Osaka (JP)

(73) Assignee: KYOCERA Document Solutions Inc., Osaka (JP)

(21) Appl. No.: 14/201,792

(22) Filed: Mar. 8, 2014

(30) Foreign Application Priority Data
Mar. 12, 2013 (JP) 2013-049655
Mar. 12, 2013 (JP) 2013-049656

(51) Int. Cl. G06Q 10/00

(52) U.S. Cl. CPC G06Q 10/20
USPC 705/305

(57) ABSTRACT

An electronic apparatus includes: an operation panel configured to display a screen for a user and receive an operation by the user; a display control unit configured to control display of a screen on the operation panel; and an agent unit configured to control timings of starting and cancelling display of a message screen based on message data received from a remote maintenance server on a maintenance service provider side. The agent unit is further configured to generate reading confirmation data that indicates that a user read the message screen and transmit the reading confirmation data to the remote maintenance server if the operation panel receives an operation by the user for cancelling display of the message screen while the message screen is displayed on the operation panel.

### CROSS-REFERENCE TO RELATED APPLICATIONS

This application relates to and claims priority rights from Japanese Patent Application No. 2013-049655, filed on Mar. 12, 2013, and Japanese Patent Application No. 2013-049656, filed on Mar. 12, 2013, the entire disclosures of which are hereby incorporated by reference herein.

### BACKGROUND

1. Field of the Present Disclosure

The present disclosure relates to an electronic apparatus, a computer readable recording medium, and a message management system.

2. Description of the Related Art

In an image forming apparatus management system, a management apparatus informs a scheduled maintenance date and time to an image forming apparatus, and the image forming apparatus displays the scheduled maintenance date and time on an operation panel.

However, in the aforementioned system, a maintenance service provider side can not know whether or not an end user reads a message such as the scheduled maintenance date and time displayed on the operation panel. In addition, even if an end user reads such a message, a maintenance service provider side can not know who reads the message.

### SUMMARY

An electronic apparatus according to an aspect of the present disclosure, includes: an operation panel configured to display a screen for a user and receive an operation by the user; a display control unit configured to control display of a screen on the operation panel; and an agent unit configured to control timings of starting and canceling display of a message screen based on message data received from a remote maintenance server on a maintenance service provider side. The agent unit is further configured to generate reading confirmation data that indicates that a user read the message screen and transmit the reading confirmation data to the remote maintenance server if the operation panel receives an operation by the user for canceling display of the message screen while the message screen is displayed on the operation panel.

An electronic apparatus according to an aspect of the present disclosure, includes: an operation panel configured to display a screen for a user and receive an operation by the user; a display control unit configured to control display of a screen on the operation panel; and an agent unit configured to control timings of starting and canceling display of a message screen based on message data received from a remote maintenance server on a maintenance service provider side. The display control unit is further configured to cause the operation panel to display the message screen if the message data has not been deleted. The agent unit is further configured (a) to cancel display of the message screen until a user logs out if the operation panel receives a first operation by the user to cancel display of the message screen while the message screen is displayed on the operation panel, and (b) to delete the message data if the first operations by all users specified in an apparatus setting are received.

A non-transitory computer readable recording medium according to an aspect of the present disclosure stores a message display control program. In an electronic apparatus that comprises an operation panel configured to display a screen for a user and receive an operation by the user, the message display control program causes a computer to act as: a display control unit that controls display of a screen on the operation panel; and an agent unit that controls timings of starting and canceling display of a message screen based on message data received from a remote maintenance server on a maintenance service provider side. The agent unit generates reading confirmation data that indicates that a user read the message screen and transmits the reading confirmation data to the remote maintenance server if the operation panel receives an operation by the user for the removing display of the message screen while the message screen is displayed on the operation panel.

A non-transitory computer readable recording medium according to an aspect of the present disclosure stores a message display control program. In an electronic apparatus that comprises an operation panel configured to display a screen for a user and receive an operation by the user, the message display control program causes a computer to act as: a display control unit that controls display of a screen on the operation panel; and an agent unit that controls timings of starting and canceling display of a message screen based on message data received from a remote maintenance server on a maintenance service provider side. The display control unit causes the operation panel to display the message screen if the message data has not been deleted. The agent unit (a) cancels display of the message screen until a user logs out if the operation panel receives a first operation by the user to cancel display of the message screen while the message screen is displayed on the operation panel, and (b) deletes the message data if the first operations by all users specified in an apparatus setting are received.

A message management system according to an aspect of the present disclosure, includes the aforementioned electronic apparatus, a remote maintenance server on a maintenance service provider side for the electronic apparatus.

These and other objects, features and advantages of the present disclosure will become more apparent upon reading of the following detailed description along with the accompanied drawings.

### BRIEF DESCRIPTION OF THE DRAWINGS

FIG. 1 shows a configuration of a message management system according to Embodiment 1 of the present disclosure;

FIG. 2 shows a diagram that indicates an example of an operation panel 11 of an image forming apparatus 1 shown in FIG. 1;

FIG. 3 shows an example of a digital note displayed on the operation panel 11 of the image forming apparatus 1 shown in FIG. 1;

FIG. 4 shows a message management process in the message management system shown in FIG. 1 (in a case that the image forming apparatus 1 receives digital note data before a user logs in the image forming apparatus 1);

FIG. 5 shows a message management process in the message management system shown in FIG. 1 (in a case that the image forming apparatus 1 receives digital note data in a period while a user logs in the image forming apparatus 1);

FIG. 6 shows an example of a digital note displayed on the operation panel 11 of the image forming apparatus 1 in Embodiment 2;

FIG. 7 shows a message management process in Embodiment 2; and

FIG. 8 shows a message management process in Embodiment 3.

### DETAILED DESCRIPTION

Hereinafter, an embodiment according to an aspect of the present disclosure will be explained with reference to drawings.

### Embodiment 1

FIG. 1 shows a configuration of a message management system according to Embodiment 1 of the present disclosure.

In the system shown in FIG. 1, an image forming apparatus 1 is located on a customer side of a maintenance service, the image forming apparatus 1 is connected to a network 2, and a remote maintenance server 3 located on a maintenance service provider side transmits message data such as a maintenance message through the network 2 from a remote location to the image forming apparatus 1 to display a message based on the message data on the image forming apparatus 1.

Hereinafter this message is called as “digital note”. The digital note may include not only information on maintenance but advertisement and the like. The digital note is configured as a text, an image, and/or the like.

The message data is generated in a server terminal apparatus 4 on the maintenance service provider side, registered in the remote maintenance server 3 from the service terminal apparatus 4, transmitted by the remote maintenance server 3, and received by an image forming apparatus 1.

Specifically, a service person of the maintenance service provider specifies an image forming apparatus 1 on which a digital note is to be displayed, and inputs a content of the digital note by operating the service terminal apparatus 4. The service terminal apparatus 4 such as a personal computer generates message data of the digital note according to the operation by the service person, and registers the message data in the remote maintenance server 3.

The image forming apparatus 1 is an electronic apparatus including an operation panel 11, here a multi function peripheral.

In addition to the operation panel 11, the image forming apparatus 1 includes a printing device 12, an image scanning device 13, a facsimile device 14, a communication device 15, and a control device 16.

The operation panel 11 is arranged on a top surface of a housing of the image forming apparatus 1, and includes a display device 21 that displays a screen to a user and an input device 22 that receives an operation by the user. The display device 21 includes a crystal liquid display or the like. The input device 22 includes a hard key, a touch panel that forms a soft key in cooperation with the display device 21, or the like.

The printing device 12 is an internal device that performs printing an image based on image data, for example, in an electrographic manner.

The image scanning device 13 is an internal device that optically scans a document image of a document and generates image data of the document image.

The facsimile device 14 is an internal device that transmits a facsimile signal of a document image and receives a facsimile signal and generates image data of a document image from the received facsimile signal.

The communication device 15 is an internal device that is connected to the network 2, and performs data commutation with another device (here, the remote maintenance server 3) connected to the network 2. For example, the communication device 15 is a network interface or a modem.

The control device 16 includes a computer and forms sorts of processing units by loading a message display control program and the like from an unshown storage device or a recording medium and executing the programs. The control device 16 forms a display control unit 23, a user managing unit 24, and an agent unit 25.

The display control unit 23 controls display of a screen on the display device 21 of the operation panel 11.

The display control unit 23 (a) causes the operation panel 11 to display the message screen on the top layer so as to overlap the login screen when the message screen is to be displayed while the login screen is displayed, and (b) causes the operation panel 11 to display the login screen on the top layer upon removing the message screen that overlaps the login screen when display of the message screen is canceled.

Further, the display control unit 23 (c) causes the operation panel 11 to display an operation screen after canceling display of the login screen, (d) causes the operation panel 11 to display the message screen on the top layer so as to overlap the operation screen when the message screen is to be displayed while the operation screen is displayed, and (e) causes the operation panel 11 to display the operation screen on the top layer upon removing the message screen that overlaps the operation screen when display of the message screen is canceled.

The user managing unit 24 determines whether login of a user is allowed or not on the basis of user information (e.g. user identification information, user authority information, and the like) on a registered user stored in an unshown storage device. The user identification information may be a user ID, a couple of a user ID and a password, or the like. The user authority information is information that indicates a user type such as an administrator or a normal user.

The user managing unit 24 causes the operation panel 11 to display a login screen using the display control unit 23 while a user does not log in. If login is allowed on the basis of user identification information when the operation panel 11 receives an input operation of the user identification information by the user for login while the login screen is displayed, the user managing unit 24 cancels display of the login screen using the display control unit 23.

The agent unit 25 receives message data of a digital note transmitted from the remote maintenance server 3 on the maintenance service provider side using the communication device 15, and controls timings of starting and canceling display of a message screen based on the received message data. Further, if the operation panel 11 receives an operation by a user for canceling display of the message screen while the message screen is displayed on the operation panel 11, the agent unit 25 generates reading confirmation data that indicates that this user read the message screen, and transmits the reading confirmation data to the remote maintenance server 3.

Furthermore, if login is allowed on the basis of the user identification information received while the login screen is displayed after canceling display of the message screen, then the agent unit 25 transmits reading confirmation data that includes the user identification information to the remote maintenance server 3.

Furthermore, if display of the message screen of the digital note is canceled while a user logs in (i.e. in a period after login of a user is allowed and before the user logs out), then the agent unit 25 acquires the user identification information on the user who currently logs in from the user managing unit 24, and transmits reading confirmation data that includes the acquired user identification information to the remote maintenance server 3.

In Embodiment 1, the agent unit 25 transmits reading confirmation data that includes not only the user identification information on the user but user authority information on the user to the remote maintenance server 3.

FIG. 2 shows an example of an operation panel 11 of an image forming apparatus 1 shown in FIG. 1. The operation panel 11 shown in FIG. 2 includes hard keys 51 to 55 and a touch panel 56 as the input device 22. The hard key 51 is a POWER key, the hard key 52 is a START key, the hard key 53 is a STOP/CLEAR key, the hard keys 54 are numeric keys, the hard key is a LOGOUT key. The touch panel 56 is arranged on a surface of the display device 21.

In FIG. 2, a login screen 61 is displayed on the display device 21 of the operation panel 11. In the login screen 61, displayed are input fields for input of a user ID (user name) and a password, a LOGIN key 62 to cause user authentication for login and cancellation of display of the login screen 61, an ID CARD LOGIN key 63 for login using an ID card, and so forth. For example, for input of a user ID and a password, numeric keys (the hard keys 54) are used.

FIG. 3 shows an example of a digital note displayed on the operation panel 11 of the image forming apparatus 1 shown in FIG. 1.

In FIG. 3, a message screen 71 is displayed on the display device 21 of the operation panel 11. In the message screen 71, displayed are a message that is the digital note (here, a text message), an OK key 72 to cancel display of the message screen 71, and so forth.

Returning to FIG. 1, the remote maintenance server 3 includes a communication processing unit 31 and a data managing unit 32. The communication processing unit 31 receives message data of a digital note from the service terminal apparatus 4 and transmits the message data to an image forming apparatus 1 as its destination. The data managing unit 32 receives reading confirmation data from the image forming apparatus 1, and transmits the received reading confirmation data to the service terminal apparatus as a response to a request received from the service terminal apparatus 4.

In the following part, a message management process in Embodiment 1 is explained.

FIG. 4 shows a message management process in the message management system shown in FIG. 1 (in a case that the image forming apparatus 1 receives digital note data before a user logs in the image forming apparatus 1). FIG. 5 shows a message management process in the message management system shown in FIG. 1 (in a case that the image forming apparatus 1 receives digital note data in a period while a user logs in the image forming apparatus 1).

In a service center or the like, a service person specifies an image forming apparatus 1 on which a digital note is to be displayed and inputs a content of the digital note by operating the service terminal apparatus 4. The service terminal apparatus 4 generates message data of the digital note in accordance with the operation (in Step S1), and transmits the message data and identification information on the image forming apparatus with a digital note registration instruction to the remote maintenance server 3 (in Step S2).

In the remote maintenance server 3, when the communication processing unit 31 receives the message data and the identification information on the image forming apparatus 1 with the digital note registration instruction, the data managing unit 32 firstly stores the message data and the identification information, and transmits the message data with a digital note display instruction to the specified the image forming apparatus 1 (in Step S3). Either the digital note or the digital note display instruction includes a digital note ID.

In the image forming apparatus 1, upon receiving the digital note display instruction and the message data using the communication device 15, the agent unit 25 causes the operation panel 11 to display a message screen based on the message data using the display control unit 23 (in Step S4).

As shown in FIG. 4, if at this time the operation panel 11 displays the login screen 61 as shown in FIG. 2 (in Step S21), the display control unit 23 causes the operation panel 11 to display the message screen 71 as shown in FIG. 3 so as to overlap the login screen 61 as shown in FIG. 2.

Thus, in a period that no users log in, the login screen 61 is displayed on the operation panel 11, and if a digital note display instruction is received at such a time, the message screen 71 is displayed so as to overlap the login screen 61. Therefore, in this status, since the login screen 61 is covered with the message screen 71 of a digital note, a user can not log in using the login screen 61 until the user cancels display of the message screen 71.

When a user performs an operation for canceling display to the message screen 71 of a digital note (for example, pressing down the OK key 72 in FIG. 3), the agent unit 25 detects the operation performed to the operation panel 11 (in Step S5), and causes the display control unit 23 to cancel display of the message screen of a digital note (in Step S6). The display control unit 23 cancels display of the message screen 71 of the digital note and consequently causes to display the login screen 61 on the top layer. In this status, since the login screen 61 is displayed on the top layer, the user can perform a login operation (for example, inputting a user ID and a password) to the login screen 61.

When the user performs a login operation to the login screen 61, the user managing unit 24 detects the operation to the operation panel 11, performs user authentication, and allows the user to log in if the user authentication succeeded and denies login if the user authentication failed. If the user managing unit 24 allowed the login, the display control unit 23 cancels display of the login screen and causes the operation panel 11 to display an operation screen (for example, an initial screen such as a main menu screen). If the user managing unit 24 denied the login, the display control unit 23 causes the operation panel 11 to continue to display the login screen 61 (or display the message screen 71 again so as to overlap the login screen 61).

Further, if the login is allowed, the agent unit 25 acquires user information such as a user ID and authority information from the user managing unit 24 (in Step S8), generates reading confirmation data that includes the digital note ID and the acquired user information (in Step S9), and transmits the reading confirmation data to the remote maintenance server 3 (in Step S10).

Contrarily, as shown in FIG. 5, if the digital note display instruction and the message data are received while a user logs in (in Step S31), the agent unit 25 acquires user information such as a user ID and authority information from the user managing unit 24 (in Step S32), generates reading confirmation data that includes the digital note ID and the user information (in Step S9), and transmits the reading confirmation data to the remote maintenance server 3 (in Step S10).

After the reading confirmation data is transmitted from the image forming apparatus 1 in the aforementioned manner, in the remote maintenance server 3, the communication processing unit 31 receives the reading confirmation data and the data managing unit 32 stores the received reading confirmation data (in Step S11). For example, the data managing unit 32 stores the reading confirmation data so as to relate the digital note to the reading confirmation data corresponding to the digital note.

Afterward, the service person can read the reading confirmation data of the digital note by operating the service terminal apparatus 4. In accordance with this operation, the service terminal apparatus 4 transmits a reading confirmation request corresponding to the digital note issued by the service person to the remote maintenance server 3 (in Step S12). The remote maintenance server 3 transmits reading confirmation data specified with the reading confirmation request to the service terminal apparatus 4 (in Step S13). The service terminal apparatus 4 receives the reading confirmation data and displays the digital note and information on the user who read the digital note (in Step S14). Therefore, the service person can confirm that the digital note has been read and who read the digital note.

In the aforementioned Embodiment 1, if the operation panel 11 receives an operation by a user for canceling display of the message screen 71 of a digital note while the message screen 71 is displayed on the operation panel 11, the agent unit 25 generates reading confirmation data that indicates that this user read the message screen, and transmits the reading confirmation data to the remote maintenance server 3.

Therefore, the maintenance service provider side grasps whether a message (i.e. digital note) transmitted from a remote location by the maintenance service provider side was read by an end user.

### Embodiment 2

A message management system according to Embodiment 2 of the present disclosure basically has the same configuration as that of the message management system according to Embodiment 1 (FIGS. 1 and 2), but has a different point as follows.

In Embodiment 2, if the message data received from the remote maintenance server 3 has not been deleted, the display control unit 23 causes the operation panel 11 to display a message screen based on the message data.

In Embodiment 2, if the message data has not been deleted, the display control unit 23 causes the operation panel 11 to display a message screen based on the message data so as to overlap a login screen.

Further, the agent unit 25 determines whether the agent unit 25 should delete the message data or not on the basis of an apparatus setting stored in an unshown built-in storage device.

In Embodiment 2, items in the apparatus setting include (1) setting item #1: only a user with an administrator authority can delete message data (value: ON or OFF), (2) setting item #2: message data is deleted when the message data is read by all of one or more specified users (value: ON or OFF), and so forth. If a value of the setting item #2 is set as ON, a user ID of the specified user is registered with the value.

The agent unit 25 (a) cancels display of the message screen until a user logs out if the operation panel 11 receives a first operation by a user to cancel display of the message screen while the message screen is displayed on the operation panel 11, and (b) deletes the message data when the first operations by all users specified in an apparatus setting (here, the setting item #2) are received if a setting value of the setting item #2 is ON.

When the message data is deleted, display of the message screen based on the message data is terminated. Contrarily, if the display is canceled, then after the user logs out, the message screen is displayed only for another user.

Further, in a case that a setting value of the setting item #1 is ON, if the operation panel 11 receives a second operation by a user to cancel display of the message screen while the message screen is displayed on the operation panel 11 and the user is a user specified in the apparatus setting (here, the setting item #1), the agent unit 25 deletes the message data; and in this case, if the user is not a user specified in the apparatus setting, the agent unit 25 does not deletes the message data.

Furthermore, if the operation panel 11 receives the aforementioned first operation while the message screen is displayed on the operation panel 11, the agent unit 25 causes the operation panel 11 to display the login screen on the top layer upon removing the message screen that overlaps the login screen using the display control unit 23 and identifies a user who performed the first operation on the basis of user identification information inputted into the login screen.

FIG. 6 shows an example of a digital note displayed on the operation panel 11 of the image forming apparatus 1 in Embodiment 2.

The message screen 71 is displayed on the display device 21 of the operation panel 11. In Embodiment 2, in the message screen 71, a message that is the digital note (here, a text message), the OK key 72, an “INFORM LATER” key 73, a CANCEL key 74, and so forth are displayed.

The OK key 72 is a soft key to cancel display of the message screen 71 and reflects that a user who pressed down this key 72 read the message. The “INFORM LATER” key 73 is a soft key to cancel display of the message screen 71 and but reflects that a user who pressed down this key 72 has not read the message yet (if a user wants to confirm the digital note later, the user presses down this “INFORM LATER” key 73). The CANCEL key 74 is a soft key to cancel display of the message screen 71 and request deleting the message data.

In the following part, a message management process in Embodiment 2 is explained.

FIG. 7 shows a message management process in Embodiment 2.

In a service center or the like, a service person specifies an image forming apparatus 1 on which a digital note is to be displayed and inputs a content of the digital note by operating the service terminal apparatus 4. The service terminal apparatus 4 generates message data of the digital note in accordance with the operation (in Step S101), and transmits the message data and identification information on the image forming apparatus with a digital note registration instruction to the remote maintenance server 3 (in Step S102).

In the remote maintenance server 3, when the communication processing unit 31 receives the message data and the identification information on the image forming apparatus 1 with the digital note registration instruction, the data managing unit 32 firstly stores the message data and the identification information, and transmits the message data with a digital note display instruction to the specified the image forming apparatus 1 (in Step S3). The digital note display instruction includes a digital note ID.

In the image forming apparatus 1, upon receiving the digital note display instruction and the message data using the communication device 15, the agent unit 25 causes the operation panel 11 to display a message screen based on the message data using the display control unit 23 (in Step S104).

If at this time the operation panel 11 displays the login screen 61 as shown in FIG. 2 (in Step S121), the display control unit 23 causes the operation panel 11 to display the message screen 71 as shown in FIG. 6 so as to overlap the login screen 61 as shown in FIG. 2.

Thus, in a period that no users log in, the login screen 61 is displayed on the operation panel 11, and if a digital note display instruction is received at such a time, the message screen 71 is displayed so as to overlap the login screen 61. Therefore, in this status, since the login screen 61 is covered with the message screen 71 of a digital note, a user can not log in using the login screen 61 until the user cancels display of the message screen 71.

When a user performs an operation for canceling display to the message screen 71 of a digital note (for example, pressing down any key among the OK key 72, the “INFORM LATER” key 73 and the CANCEL key 74” in FIG. 6), the agent unit 25 detects the operation performed to the operation panel 11 (in Step S105), and causes the display control unit 23 to cancel display of the message screen of a digital note (in Step S106). The display control unit 23 cancels display of the message screen 71 of the digital note and consequently causes to display the login screen 61 on the top layer. In this status, since the login screen 61 is displayed on the top layer, the user can perform a login operation (for example, inputting a user ID and a password) to the login screen 61.

When the user performs a login operation to the login screen 61, the user managing unit 24 detects the operation to the operation panel 11, performs user authentication (in Step S107), and allows the user to log in if the user authentication succeeded and denies login if the user authentication failed. If the user managing unit 24 allowed the login, the display control unit 23 cancels display of the login screen 61 and causes the operation panel 11 to display an operation screen (for example, an initial screen such as a main menu screen). If the user managing unit 24 denied the login, the display control unit 23 causes the operation panel 11 to continue to display the login screen 61 (or display the message screen 71 again so as to overlap the login screen 61).

Further, if the login is allowed, the agent unit 25 acquires user information such as a user ID and authority information from the user managing unit 24 (in Step S108), generates reading confirmation data that includes the digital note ID and the acquired user information (in Step S109), and stores the reading confirmation data in the image forming apparatus 1 (in Step S110).

In a case that a setting value of the setting item #2 is ON, (a) if the first operation (here, pressing down the OK key 72) is performed, then the agent unit 25 identifies a user who performed this first operation on the basis of the user information, and (b) subsequently if the identified user is a user specified in the apparatus setting, the agent unit 25 registers that the user has read the message (in Step S110).

Further, if a setting value of the setting item #2 is ON, when all of the specified users have read the message, the agent unit 25 deletes the message data; and in a case that the setting item #1 is set as ON, if the second operation (here, pressing down the CANCEL key 74) is performed, the agent unit 25 (a) identifies a user who performed this second operation and (b) deletes the message data if the identified user has specific user authority (here, administrator authority) (in Step S111).

Afterward, if the hard key 55 as a LOGOUT key is pressed down, the display control unit 23 performs a logout process and causes the operation panel 11 to display the login screen 61 again. If the message data has not been deleted yet at this time, the message screen 71 based on the message data is displayed so as to overlap the login screen 61.

In the aforementioned Embodiment 2, if message data has not been deleted, the display control unit 23 causes the operation panel 11 to display the message screen 71; and if the operation panel 11 receives a first operation by a user while the message screen 71 is displayed on the operation panel 11, the agent unit 25 (a) cancels display of the message screen 71 until the user logs out, and (b) deletes the message data if the first operations by all of one or more users specified in an apparatus setting are received.

Therefore, a digital note is repeatedly displayed until all of the specified users read the digital note, and therefore, it is possible to have the specified user surely read the digital note. Consequently, in the image forming apparatus 1, it is possible to have a specific user read a digital note transmitted from a remote location on the maintenance service provider side.

### Embodiment 3

Although a message screen is displayed so as to overlap a login screen in Embodiment 2, a login screen is displayed so as to overlap a message screen in Embodiment 3.

A system according to Embodiment 3 basically has the same configuration as that of the system according to Embodiment 2, but in the image forming apparatus 1, the display control unit 23 and the user managing unit 24 run in the following manner in Embodiment 3.

In Embodiment 3 as well, the agent unit 25 determines whether the agent unit 25 should delete the message data or not on the basis of an apparatus setting stored in an unshown built-in storage device.

In Embodiment 3, items in the apparatus setting include (1) setting item #1: only a user with an administrator authority can delete message data (value: ON or OFF), (2) setting item #2: message data is deleted when the message data is read by all of one or more specified users (value: ON or OFF), (3) setting item #3: a digital note (a message screen) is displayed only when a user with administrator authority logs in (value: ON or OFF), (4) setting item #4: a digital note (a message screen) is displayed only when a specified user logs in (value: ON or OFF), and so forth. If at least one of values of the setting items #2 and #4 is set as ON, a user ID of the specified user is registered with the value.

In Embodiment 3, if the message data has not been deleted, the display control unit 23 causes the operation panel 11 to display the login screen so as to overlap the message screen. If login of a user who performed a login operation is allowed, the agent unit 25 cancels display of the login screen. When display of the login screen is canceled, if the user identified by the user identification information is a user specified in the apparatus setting, the agent unit 25 causes the operation panel 11 to display the message data. Otherwise, when display of the login screen is canceled, if the user identified by the user identification information is not a user specified in the apparatus setting, the agent unit 25 cancels display of the message screen.

Further, in Embodiment 3, if the agent unit 25 causes to display the message screen, the agent unit 25 identifies a user who performed the first operation to the message screen on the basis of the user identification information as well as in Embodiment 2.

In the following part, a message management process in Embodiment 3 is explained.

FIG. 8 shows a message management process in Embodiment 3.

In a service center or the like, a service person specifies an image forming apparatus 1 on which a digital note is to be displayed and inputs a content of the digital note by operating the service terminal apparatus 4. The service terminal apparatus 4 generates message data of the digital note in accordance with the operation (in Step S131), and transmits the message data and identification information on the image forming apparatus with a digital note registration instruction to the remote maintenance server 3 (in Step S132).

When receiving the message data and the identification information on the image forming apparatus 1 with the digital note registration instruction, the remote maintenance server 3 firstly stores the message data and the identification information, and transmits the message data with a digital note display instruction to the specified the image forming apparatus 1 (in Step S133). The digital note display instruction includes a digital note ID.

In the image forming apparatus 1, upon receiving the digital note display instruction and the message data using the communication device 15, the agent unit 25 causes the operation panel 11 to display a message screen based on the message data using the display control unit 23 (in Step S134).

If at this time the operation panel 11 displays the login screen 61 as shown in FIG. 2 (in Step S151), the display control unit 23 causes the operation panel 11 to display the login screen 61 as shown in FIG. 2 so as to overlap the message screen 71 as shown in FIG. 6. Thus, the login screen 61 is displayed at the top layer and the message screen is displayed at a lower layer than the top layer, and consequently in this status, a user can not see the message screen 71. Therefore, in this status, the user can perform a login operation (for example, inputting a user ID and a password) to the login screen 61.

When the user performs a login operation to the login screen 61 displayed at the top layer, the user managing unit 24 detects the operation to the operation panel 11, performs user authentication (in Step S135), and allows the user to log in if the user authentication succeeded and denies login if the user authentication failed. If the user managing unit 24 allowed the user to log in, the display control unit 23 cancels display of the login screen 61. If the user managing unit 24 denied login, the display control unit 23 continues display of the login screen 61.

Further, if the login is allowed, the agent unit 25 acquires user information such as a user ID and authority information from the user managing unit 24 (in Step S136).

Subsequently, in a case that a setting value of the setting item #3 is ON, if the agent unit 25 determined that a user who logs in does not have administrator authority on the basis of the user information, the agent unit 25 cancels display of the message screen. In a case that a setting value of the setting item #4 is ON, if the agent unit 25 determined that a user who logs in is not the specified user, the agent unit 25 cancels display of the message screen (in Step S137).

If display of the message screen 71 is not canceled at this time, the agent unit 25 causes the operation panel 11 to display the message screen 71 of the digital note at the top layer using the display control unit 23.

When the user performs an operation for canceling display to the message screen 71 of a digital note (for example, pressing down any key among the OK key 72, the “INFORM LATER” key 73 and the CANCEL key 74” in FIG. 6), the agent unit 25 detects the operation performed to the operation panel 11 (in Step S138), and causes the display control unit 23 to cancel display of the message screen of a digital note (in Step S139). The display control unit 23 cancels display of the message screen 71 of the digital note and consequently causes to display an operation screen on the top layer.

Subsequently, the agent unit 25 generates reading confirmation data that includes the digital note ID and the user information (in Step S140), and stores the reading confirmation data in the image forming apparatus 1 (in Step S141).

Further, if the setting item #2 is set as ON, when all of the specified users have read the message, the agent unit 25 deletes the message data; and in a case that the setting item #1 is set as ON, if the second operation (here, pressing down the CANCEL key 74) is performed, the agent unit 25 (a) identifies a user who performed this second operation and (b) deletes the message data if the identified user has specific user authority (here, administrator authority) (in Step S142).

Afterward, when the hard key 55 as a LOGOUT key is pressed down, the display control unit 23 performs a logout process and causes the operation panel 11 to display the login screen 61 again. If the message data has not been deleted at this time, the message screen 71 based on the message data is displayed when display of the login screen 61 is canceled.

In the aforementioned Embodiment 3, when a specified user logs in, a digital note is displayed and a digital note is repeatedly displayed until all of the specified users read the digital note, and therefore, it is possible to have the specified user surely read the digital note. Consequently, in the image forming apparatus 1, it is possible to have a specific user read a digital note transmitted from a remote location on the maintenance service provider side.

The description has been presented for purposes of illustration and description, and is not intended to be exhaustive or limited.

For example, in Embodiment 1, the login function based on user authentication may be turned on/off in accordance with a setting. In such a case, if the login function is turned on, the image forming apparatus 1 runs in the aforementioned manner; and if the login function is turned off, in the image forming apparatus 1, the login screen 61 is not displayed, and when display of the message screen 71 is canceled, the operation screen is immediately displayed and the reading confirmation data that includes a user ID of “unknown” and user authority information of a normal user is generated and transmitted to the remote maintenance server 3.

Further, in Embodiment 2 or 3, the login function based on user authentication may be turned on/off in accordance with a setting. In such a case, if the login function is turned on, the image forming apparatus 1 runs in the aforementioned manner; and if the login function is turned off, in the image forming apparatus 1, the login screen is not displayed, and when display of the message screen is canceled, the operation screen is immediately displayed and the reading confirmation data that includes a user ID of “unknown” and user authority information of a normal user is generated and transmitted to the remote maintenance server 3.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An electronic apparatus, comprising:
an operation panel configured to display a screen for a user and receive an operation by the user;
a display control unit configured to control display of a screen on the operation panel; and
an agent unit configured to control timings of starting and canceling display of a message screen based on message data received from a remote maintenance server on a maintenance service provider side;
wherein the agent unit is further configured to generate reading confirmation data that indicates that a user read the message screen and transmit the reading confirmation data to the remote maintenance server if the operation panel receives an operation by the user for canceling display of the message screen while the message screen is displayed on the operation panel.

2. The electronic apparatus according to claim 1, further comprising a user managing unit configured to cause the operation panel to display a login screen using the display control unit while a user does not log in the electronic apparatus, and cancel display of the login screen if login is allowed on the basis of user identification information when the operation panel receives an input operation of the user identification information by the user for login while the login screen is displayed;
wherein the display control unit is further configured (a) to cause the operation panel to display the message screen on the top layer so as to overlap the login screen when the message screen is to be displayed while the login screen is displayed, and (b) to cause the operation panel to display the login screen on the top layer upon removing the message screen that overlap the login screen when display of the message screen is canceled; and
the agent unit is further configured to transmit the reading confirmation data that includes the user identification information to the remote maintenance server if login is allowed on the basis of the user identification information received while the login screen is displayed after canceling display of the message screen.

3. The electronic apparatus according to claim 2, wherein:
the display control unit is further configured (c) to cause the operation panel to display an operation screen after canceling display of the login screen, (d) to cause the operation panel to display the message screen on the top layer so as to overlap the operation screen when the message screen is to be displayed while the operation screen is displayed, and (e) to cause the operation panel to display the operation screen on the top layer upon removing the message screen that overlap the operation screen when display of the message screen is canceled; and
the agent unit is further configured to acquire the user identification information on a user who currently logs in from the user managing unit when display of the message screen is canceled, and transmit the reading confirmation data that includes the acquired user identification information to the remote maintenance server.

4. The electronic apparatus according to claim 2, wherein the agent unit is further configured to transmit the reading confirmation data that includes user authority information with the user identification information to the remote maintenance server.

5. The electronic apparatus according to claim 1, wherein the message data is generated in a service terminal apparatus on the maintenance service provider side, registered in the remote maintenance server from the service terminal apparatus, transmitted by the remote maintenance server, and received by the electronic apparatus.

6. An electronic apparatus, comprising:
an operation panel configured to display a screen for a user and receive an operation by the user;
a display control unit configured to control display of a screen on the operation panel; and
an agent unit configured to control timings of starting and canceling display of a message screen based on message data received from a remote maintenance server on a maintenance service provider side;
wherein the display control unit is further configured to cause the operation panel to display the message screen if the message data has not been deleted; and
the agent unit is further configured (a) to cancel display of the message screen until a user logs out if the operation panel receives a first operation by the user to cancel display of the message screen while the message screen is displayed on the operation panel, and (b) to delete the message data if the first operations by all users specified in an apparatus setting are received.

7. The electronic apparatus according to claim 6, wherein the agent unit is further configured to delete the message data if the operation panel receives a second operation by a user to cancel display of the message screen while the message screen is displayed on the operation panel and the user is a user specified in the apparatus setting, and not to delete the message data if the user is not a user specified in the apparatus setting.

8. The electronic apparatus according to claim 6, further comprising a user managing unit configured to cause the operation panel to display a login screen using the display control unit while a user does not log in the electronic apparatus, and cancel display of the login screen if login is allowed on the basis of user identification information when the operation panel receives an input operation of the user identification information by the user for login while the login screen is displayed;
wherein the display control unit is further configured to cause the operation panel to display the message screen so as to overlap the login screen if the message data has not been deleted; and
the agent unit is further configured (c) to cause the operation panel to display the login screen on the top layer upon removing the message screen that overlaps the login screen when the operation panel receives the first operation while the message screen is displayed on the operation panel, and (d) to identify a user who performed the first operation on the basis of the user identification information.

9. The electronic apparatus according to claim 6, further comprising a user managing unit configured to cause the operation panel to display a login screen using the display control unit while a user does not log in the electronic apparatus, and cancel display of the login screen if login is allowed on the basis of user identification information when the operation panel receives an input operation of the user identification information by the user for login while the login screen is displayed;
wherein the display control unit is further configured to cause the operation panel to display the login screen so as to overlap the message screen if the message data has not been deleted; and
the agent unit is further configured to cause the operation panel to display the message data when display of the login screen is canceled if a user identified by the user identification information is a user specified in the apparatus setting, and cancel display of the message screen when display of the login screen is canceled if a user identified by the user identification information is not a user specified in the apparatus setting.

10. The electronic apparatus according to claim 9, wherein the agent unit is configured to identify a user who performed the first operation on the basis of the user identification information if the agent unit causes the operation panel to display the message screen.

11. A non-transitory computer readable recording medium storing a message display control program;
wherein in an electronic apparatus that comprises an operation panel configured to display a screen for a user and receive an operation by the user, the message display control program causes a computer to act as:
a display control unit that controls display of a screen on the operation panel; and
an agent unit that controls timings of starting and canceling display of a message screen based on message data received from a remote maintenance server on a maintenance service provider side;
wherein the agent unit generates reading confirmation data that indicates that a user read the message screen and transmits the reading confirmation data to the remote maintenance server if the operation panel receives an operation by the user for the removing display of the message screen while the message screen is displayed on the operation panel.

12. A non-transitory computer readable recording medium storing a message display control program;
wherein in an electronic apparatus that comprises an operation panel configured to display a screen for a user and receive an operation by the user, the message display control program causes a computer to act as:
a display control unit that controls display of a screen on the operation panel; and
an agent unit that controls timings of starting and canceling display of a message screen based on message data received from a remote maintenance server on a maintenance service provider side;
wherein the display control unit causes the operation panel to display the message screen if the message data has not been deleted; and
the agent unit (a) cancels display of the message screen until a user logs out if the operation panel receives a first operation by the user to cancel display of the message screen while the message screen is displayed on the operation panel, and (b) deletes the message data if the first operations by all users specified in an apparatus setting are received.

13. A message management system, comprising:
an electronic apparatus; and
a remote maintenance server on a maintenance service provider side of the electronic apparatus;
wherein the electronic apparatus comprises:
an operation panel configured to display a screen for a user and receive an operation by the user;
a display control unit configured to control display of a screen on the operation panel; and
an agent unit configured to control timings of starting and canceling display of a message screen based on message data received from the remote maintenance server;
wherein the agent unit is further configured to generate reading confirmation data that indicates that a user read the message screen and transmit the reading confirmation data to the remote maintenance server if the operation panel receives an operation by the user for canceling display of the message screen while the message screen is displayed on the operation panel.

14. A message management system, comprising:
an electronic apparatus; and
a remote maintenance server on a maintenance service provider side of the electronic apparatus;
wherein the electronic apparatus comprises:
an operation panel configured to display a screen for a user and receive an operation by the user;
a display control unit configured to control display of a screen on the operation panel; and
an agent unit configured to control timings of starting and canceling display of a message screen based on message data received from the remote maintenance server;
wherein the display control unit is further configured to cause the operation panel to display the message screen if the message data has not been deleted; and
the agent unit is further configured (a) to cancel display of the message screen until a user logs out if the operation panel receives a first operation by the user to cancel display of the message screen while the message screen is displayed on the operation panel, and (b) to delete the message data if the first operations by all users specified in an apparatus setting are received.
